(19) United States
(12) Patent Application Publication
(10) Pub. No.: US 2014/0279397 A1
(43) Pub. Date: Sep. 18, 2014

(54) Retrieving Vehicular Collateral via Wi-Fi

(71) Applicant: David Warren Schmidt, Lake Forest, CA (US)

(72) Inventors: David Warren Schmidt, Lake Forest, CA (US); Kenneth Alan Wiesner, Westminster, CO (US); William James Northrup, III, Kendall, NY (US)

(21) Appl. No.: 14/209,593

(22) Filed: Mar. 13, 2014

Related U.S. Application Data
(60) Provisional application No. 61/785,005, filed on Mar. 14, 2013.
(60) Provisional application No. 61/793,544, filed on Mar. 15, 2013.

(51) Int. Cl. G06Q 40/02

(52) U.S. Cl. CPC G06Q 40/025
USPC 705/38

(57) ABSTRACT

An electronic device is installed in a vehicle used as collateral for a loan. The installed device records the location of the vehicle at periodic intervals and whenever the vehicle is stationary. The installed device also searches for and identifies a compatible Wi-Fi node that can forward data to the Internet, and transmits location information through this compatible node. The location information is stored in a central database, where it can be used to form a location profile for the vehicle and predict the vehicle's location based on past history for a given time of day or day of week. If the loan enters a past-due status, the location profile is accessed by users such as the lender, loan servicer, vehicle retriever, and associated users. Upon arriving within the vicinity of a predicted location, vehicles are more precisely located with the aid of a Wi-Fi capable mobile device. The invention also provides for sending commands from a central server to an installed device over Wi-Fi, and canceling previous commands when the vehicle is outside of Wi-Fi communication coverage.

### CROSS-REFERENCES TO RELATED APPLICATIONS

The present application claims the benefit of U.S. Provisional Application No. 61/785,005 entitled

“Expanded Wi-Fi Coverage for Remote Vehicles” filed on Mar. 14, 2013 and U.S. Provisional Application No. 61/793,544 entitled “Retrieving Vehicular Collateral via Wi-Fi ” filed on Mar. 15, 2013.

### FIELD OF THE INVENTION

The present invention relates generally to retrieving of vehicular collateral, and more specifically to a method of retrieving vehicular collateral in which a transmitting device is installed in the vehicle which provides the vehicle's location to remote users.

### BACKGROUND OF THE INVENTION

A vehicle can be used as collateral for a loan or can be subject to repossession based on the terms of a vehicle lease. Whether the original instrument is a loan or lease, hereafter referred to interchangeably, the lender has traditionally used one of two methods to retrieve the vehicle once the loan is in default. The most widely used method is a manual process of using a loan applicant's information, either from the date of the loan or as later updated, in order to find the borrower and hopefully the vehicle. The second method involves installing a locating device inside the vehicle with wireless real-time connectivity, which can be called upon to locate the vehicle when needed.

With the manual process, the lender, or someone working on the lender's behalf, must manually follow through known contact information which could include the borrower's work location, place of residence, known points of interest, and in some cases friends and/or family in order to determine a potential retrieval location. This method is obviously costly and inefficient due to the extensive manual nature of communicating with numerous sources, and time spent searching at possible locations for the vehicle.

However, existing locating devices all use proprietary, commercial data delivery networks, which come with the significant recurring cost burden of airtime fees, and can prove prohibitive for lower risk loans and lower loan amounts. Longer loan duration and the possibility that a loan will not enter default until a significant time later can exacerbate these cost burdens and justify the manual process.

Loan servicers also have an interest in communicating directly to the driver of the vehicle when there is a problem with the status of the loan. This can be as simple as instructing the vehicle to produce an audible warning alert when started, or as significant as disabling the vehicle after some period of non-payment. These means are generally resorted to when a loan servicer cannot successfully communicate with the driver of a vehicle through normal communication methods, and the vehicle is in danger of repossession. This functionality is also accomplished through the same proprietary, commercial data networks, and are thus subject to the same cost burdens.

This patent proposes to eliminate these deficiencies in notification of loan status and retrieval of vehicular collateral by using existing, cost efficient, freely available Wi-Fi communication networks.

### SUMMARY OF THE INVENTION

In view of the foregoing, there is a need to achieve the efficiency and reliability benefits of existing location devices while reducing the significant and indeterminate recurring cost burdens.

In this method, an electronic device is installed in a vehicle where it collects data regarding the location habits of the vehicle. The location data can be collected at specific times of the day, on a periodic basis, whenever a certain distance has been traveled, at moments when the vehicle is stationary for a predetermined time, or on some combination of the above. This location data is stored so that it may be transmitted later once a Wi-Fi communication path becomes available. The location data itself may be calculated based on the identifying information broadcast by nearby Wi-Fi access points, thus combining the location and communication hardware components.

The device then searches for, tests, and uses compatible Wi-Fi access points which will allow the device to forward data packets over Wi-Fi to and from the Internet. The device encrypts and transmits the collected location data using these compatible Wi-Fi networks to a central server on the Internet. Searching for, validating, and using compatible, open Wi-Fi networks instead of using a proprietary commercial wireless network removes significant cost, greatly reduces or eliminates proprietary network certifications and contract negotiations, increases compatibility for international deployments, and makes this method tenable for a larger percentage of loans. In exchange, this method sacrifices real-time connectivity, which is compensated for as presently described.

The location data is eventually received over the Internet by a central server, which stores the relevant data in a database. A central server, which may be the same as or different than the receiving server, or a user with access to the database can access this information and predict future locations for the vehicle based on the vehicle's history. These predictions can be sent to an authorized user either by responding to a user-initiated request, or by pro-actively matching and alerting a user based on predefined filters, such as the status of a loan that is associated with the vehicle.

A central server may also return a command to the device that causes the device to warn the user of a loan status or to disable the vehicle. Commands are queued at the central servers and sent whenever a communication path becomes available and re-sent until they are acknowledged by the device. Commands may also be set to only execute when the vehicle reaches a predicted location and may also contain a reversal code that can be entered locally at the vehicle in the event that a communication path is not available with the central server and the command needs to be canceled. For example, a driver may enter this code into a smart-phone that communicates directly with the device over Wi-Fi, or may enter this code by turning the vehicle's key switch on and off in a unique pattern.

When a vehicle needs to be retrieved and a predicted location is to be used, the device can be commanded in advance to broadcast or listen for a specific Wi-Fi signal when the vehicle is at the predicted location. Then, the retriever can proceed to the general predicted location and, once within Wi-Fi range, use a smart-phone to communicate directly with the vehicle and further pinpoint its location.

This patent proposes to eliminate the costly use of a proprietary, commercial data delivery network, associated hardware components, and in some cases the need for an additional and separate location-determining hardware component. It proposes several steps to alleviate the subsequent potential loss of real-time connectivity, including vehicle location predictions and direct local communication between a smart-phone and the vehicle. Such an advancement in the art would be of major benefit to the vehicle financing and leasing industries.

### BRIEF DESCRIPTION OF THE DRAWINGS

These, as well as other features of the present invention, will become more apparent upon reference to the drawings wherein:

FIG. 1 is a block diagram containing an overview of system components in an embodiment of the present invention.

FIG. 2 is a flowchart containing an overview of steps taken to warn the vehicle's driver, or disable or retrieve the vehicle in an embodiment of the present invention.

FIG. 3 is a flowchart of steps taken inside an installed device to help a mobile device locate the vehicle in an embodiment of the present invention.

FIG. 4 is a flowchart of steps taken inside a mobile device to locate a nearby vehicle in an embodiment of the present invention.

FIG. 5 is a block diagram illustrating multiple communication paths available to reverse a warning or disable command in an embodiment of the present invention.

### DETAILED DESCRIPTION OF THE PREFERRED EMBODIMENT

The term Wi-Fi, as used herein, refers to using any one or more of the IEEE (Institute of Electrical and Electronics Engineers) 802.11 standards and/or amendments.

Referring to the drawings that are for illustrating a preferred embodiment of the present invention only, and not for purposes of limiting the present invention, FIGS. 1 through 5 illustrate a system and method for using Wi-Fi networks to notify a user of a vehicle's expected current location and increase the possibility of a successful vehicle retrieval.

FIG. 1 illustrates an overview of the interaction between components used in the present system, including a vehicle 110 that is serving as collateral for a loan. This vehicle has a set of components 111,112,113,114,115,116 installed which shall be collectively referred to as an installed device. Preferably these components reside in a single package, but alternatively may be physically separated inside the vehicle. This installed device enables remote locating, warning, and disabling functionality which can be activated based on the status of the loan.

A primary objective is to return information concerning the location of vehicles to a central server 160 where it can be accessed by authorized users through a user interface 170. To do this, an installed device communicates over Wi-Fi with other installed devices, Wi-Fi Internet access points 120, and relaying devices 130. A relaying device can relay information to a Wi-Fi internet access point 120 or a cellular base station 140. In situations where a user is within Wi-Fi range of a vehicle, then a mobile device 101 can be used to directly communicate with the installed device.

Within the vehicle 110, a location receiver 111 is responsible for receiving radio frequency (RF) signals in the vehicle's environment that can be used to determine the vehicle's present location. Preferably, this is a Global Navigation Satellite System (GNSS) receiver such as Global Positioning System (GPS), GLONASS, Galileo, or Compass which allows the RF signals to be processed on-board and recorded as latitude and longitude coordinates. Alternatively, the signals could consist of the identifiers of Wi-Fi networks which are in range of the installed device and the identifiers could be stored without further processing. These Wi-Fi network identifiers can then be later cross-referenced to determine location by a database that is either on a central server 160 or inside the vehicle. Using this alternative Wi-Fi based location determination could reduce hardware costs by combining the hardware for the location receiver with the hardware for the Wi-Fi communication transceiver 113 and could allow the determination of vehicle location in areas where a GNSS fix is not attainable. However, this would come at the expense of reduced overall location coverage and accuracy in some geographical areas.

Regardless of the location determination approach, the location receiver 111 stores any location data it does acquire, along with the associated time data, in the data storage 112. This storage is necessary because, due to the limited availability of compatible Wi-Fi access points, the installed device will likely only have sporadic Internet connectivity through which it delivers this information to the central server 160. Preferably the location data consists of coordinate data stored in a summarized and compressed format. In alternative embodiments, the format of the stored data may vary greatly, and may consist of raw signal data, coordinate data, identifier data, or any other data that can be used to extract location meaning and correlate where the vehicle was located with a specific time duration or period.

The installed device communicates with other nodes using its Wi-Fi transceiver 113. The Wi-Fi transceiver scans for other Wi-Fi nodes that are within range, including compatible Wi-Fi Internet access points 120, relaying devices 130, and other installed devices. The location data is then pulled from the data storage 112 and sent through the Wi-Fi transceiver 113 to the compatible Wi-Fi node which forwards the data toward a central server 160 that is located on the Internet 150. This compatible Wi-Fi node may have direct access to the Internet, or it may need to forward the data first to other nodes that do. Preferably, all information between an installed device and a central server is encrypted with end-to-end encryption, since that data may be traversing open Wi-Fi networks and/or the open Internet.

A Wi-Fi Internet access point 120 may either be open or password protected, and the Internet access it provides may be behind either an open or captive portal. In order to communicate with a variety of Wi-Fi Internet access points, the Wi-Fi transceiver 113 and the relaying device 130 are preferably both capable of remembering passwords for known password-protected access points, executing procedures for gaining Internet access from known captive portals, and attempting unknown open Wi-Fi access points to test for suitable Internet access.

A relaying device 130 does not operate as a standard Wi-Fi Internet access point (“hotspot”), but is nonetheless capable of communicating over Wi-Fi with an installed device, receiving location data, and relaying that data toward the Internet. Examples of relaying devices include smart-phones, tablets, notebooks, or laptops; desktops; or smart televisions; wherein the relaying device is running a custom application that searches for and receives location data from installed devices. To accomplish this, the relaying device will choose a Wi-Fi mode (infrastructure client station, infrastructure access point, Wi-Fi Direct, etc.) that is compatible with the installed device's mode, establish a Wi-Fi link, and receive the location data. If the relaying device is enabled for cellular communications, then the data may be forwarded immediately to a cellular base station 140. Otherwise, the data may be stored and forwarded later to a Wi-Fi Internet access point 120 when one comes into range.

The installed device also preferably contains a warning output 114 and a vehicle disable output 115. The warning output is preferably an electro-accoustic device such as a piezo, a buzzer, or a speaker that is capable of communicating an audible warning to the vehicle's driver regarding the loan status, for instance, that the loan is in danger of soon becoming past-due unless a payment is received. The vehicle disable output temporarily disables the vehicle and can be used to induce the driver to make a late payment or to increase the likelihood that the vehicle will not move before it can be retrieved. Preferably, the vehicle disable output is implemented as a starter-interrupt relay which can disconnect the starter line of the vehicle and prevent it from starting. Alternatively, in some vehicles, the warning output and/or vehicle disable output can be implemented by sending commands over a vehicle bus. This alternative approach, although less universal, would have the desirable attribute of tighter integration with the vehicle and provide additional cost savings.

The installed device also preferably contains a reversal code input 116, which can monitor the vehicle and detect if a user is entering a code to cancel a previous command that has been sent to the installed device. This is useful, because there may not always be a path to communicate between the central server and the installed device. For example, if there are no compatible Wi-Fi nodes within range and the vehicle is disabled. The reversal code input can monitor the key state/ignition state of the vehicle for a specific pattern that can be input by a user. It can do so directly, by sensing the position of an electrical switch, or indirectly, by monitoring information on an on-board vehicle bus. It should be apparent to one skilled in the art that there are many other possible means for a driver to enter a reversal code, such as pressing the brake pedal or locking/unlocking the doors in the required pattern.

The eventual destination for the location data, a central server 160, contains several components including a location predictor 161, a loan monitor 162, and a reversal code generator 163.

The location predictor 161 analyzes the received location data, and makes predictions about the vehicle's habits and future locations, based on the time of day, day of week, holiday schedules, and the duration and frequency of the locations in the location data. While this location predictor preferably operates in the central servers, in an alternative embodiment is possible that the location predictor exists instead inside the installed device. In this case, predicted location data would be sent over the Internet in lieu of historic location data. The location predictor preferably predicts several different locations and times along with an estimated accuracy of each location and time predicted. This allows the user to choose a location for disabling or retrieving the vehicle based on other factors such as convenience, proximity to Wi-Fi communications coverage, physical access the the vehicle, etc. It is also contemplated that, in an alternative embodiment, the prediction step could be performed with the aid of a human analyst.

The loan monitor 161 is responsible for monitoring the status of the loan attached to the vehicle, and then taking appropriate programmed action. Those programmed actions may consist of engaging the location predictor or retrieving previously predicted locations and sending that information for presentation on a user interface 170. They may be triggered when the loan enters default, or a set period of time after the loan enters default. The user interface may be in the form of a web browser, an email reader, a text, telephone, voicemail reader, instant messaging application, social network, or other interface where such information will be delivered to a user. Preferably the loan monitor supports many such user interfaces. In an alternative implementation, there can be additional systems and interfaces positioned between the central servers 160 and the final user interface 170. These additional interfaces would translate, rearrange, add to, subtract from, or otherwise act on the data prior to presentation. Once an authorized user receives information from the user interface concerning the location of the vehicle, the user can then attempt to retrieve the vehicle at the predicted location and time that is most convenient.

The loan monitor may also be programmed to send a command which engages the warning output 114 or the vehicle disable output 115 based on the status or schedule of the loan. Such commands would traverse paths back from the central servers 160 through the Internet and to the vehicle 110. The reversal code generator 163 creates unique codes that can be used to reverse or cancel a command at the vehicle without the need to communicate again with a central server. This can be used, for instance, if the loan default has been cured after the vehicle is disabled but before the vehicle is retrieved, and the vehicle is outside of Wi-Fi communication coverage. Preferably the reversal code generator is located in the central server and reversal codes are sent with each command. In an alternative embodiment, the reversal code generator may be located in the vehicle and the reversal codes are sent back to the central server as part of a command acknowledgment. However, this alternative embodiment opens the possibility that if an acknowledgment is not received then a command might be executed even though the generated reversal codes remain unknown. The process of reversal code generation and entry is described in more detail in FIG. 5.

If a loan default is not cured and the vehicle needs to be retrieved, a mobile device 101 can also be used to help further pinpoint the location of the vehicle. The mobile device contains its own Wi-Fi transceiver and user interface, and communicates directly with the installed device when in the vicinity of the predicted location. This process is described in more detail in FIGS. 3 and 4.

FIG. 2 is a flowchart of a method that is used to warn the driver, disable the vehicle, and initiate retrieval of the vehicle when the loan status warrants such actions. The method begins with the installation 200 of the device in the vehicle, where the installed device is capable of monitoring the location of the vehicle and reporting vehicle location data to a central server using its Wi-Fi transceiver. Meanwhile, the central servers wait 210 to receive location data from an installed device. Preferably, the installed device is programmed to send its location data whenever communications with the central server are established. In an alternative embodiment, the installed device may be programmed, for privacy reasons, to not send any location data until explicitly instructed to do so. In this case the installed device periodically sends check messages which do not contain location information and the central server only instructs the installed device to send location data once the loan is in danger of entering, or has entered, default.

Whenever location data is received by a central server, a location profile for the vehicle is updated 220. The location profile contains the information necessary to determine where the vehicle spends most of its time and in what daily patterns, such as home and work locations, and aids in the prediction of likely places to disable or retrieve the vehicle, if such steps become necessary. After updating the location profile, the loan status is checked 230 to see if any specific commands should be sent to the installed device as a response. If the loan status warrants that the driver of the vehicle should be warned 231, then the warning command is sent 240 to the installed device and the installed device will trigger the warning to the driver. For example, the warning may trigger an audible beeping sequence each time the car is started for the next few days. If the loan status warrants disabling the vehicle 232, then an appropriate location to disable the vehicle is chosen 250 from the predicted locations, and a command to disable the starter is sent 255 to the installed device. After sending either a warning or disable command, the system waits 210 again for the next location data to arrive from the installed device, at which point it can send a reversal of a previous command or can send a new command as is warranted by the loan status.

After checking 230 the loan status, and whether warning 231 or disable 232 commands should be sent, a determination will also be made as to whether the vehicle should be retrieved 233. If not, then the central server returns to waiting 210 for the next location data to arrive from the installed device. However, if the vehicle needs to be retrieved, then the location profile is consulted and a location is chosen 260 from the predicted current or future locations of the vehicle. Finally, predicted locations are delivered to a user and an attempt is made to retrieve the vehicle at the chosen location and time 265.

Since the predicted locations may be relatively imprecise, this present invention provides a means of further refining the actual location of the vehicle at the time and place of retrieval. For example, a vehicle may be commonly parked on the street, and its exact parking location may vary over time such that the predicted location encompasses a radius of several blocks. In this case, the Wi-Fi transceiver of the installed device can be instructed to transmit a Wi-Fi signal when the predicted location is reached, and a person retrieving the vehicle can detect that signal with the use of a smart-phone or other Wi-Fi capable mobile device upon arriving in the general vicinity of the predicted location. Preferably, the Wi-Fi signal is decoded to determine the exact and current coordinate position of the vehicle. Alternatively, if the coordinate position is not available or cannot be determined, then the source of the Wi-Fi signal can be followed to discover the vehicle's current exact location.

FIG. 3 is a flowchart that diagrams the steps performed by the installed device, after the installed device has been commanded to aid a person in locating and retrieving the vehicle at a given location. First, the installed device checks 300 the current location and time. If the current location and time does not match the previously chosen location and time window, then the installed device waits 310 and checks 300 again later. When a match occurs, the Wi-Fi transceiver in the installed device turns on 320. The Wi-Fi transceiver may have already been on, or it may have been previously turned off to save power. The Wi-Fi transceiver enables communication with a different, mobile device that comes within wireless range; examples of mobile devices are smart-phones, tablets, and laptops that are operated by a person looking for the vehicle. These mobile devices are contain both a means of Wi-Fi communications and interfacing with the user. Preferably, the installed device checks for a request 330 from the mobile device. If no such request is detected, then it waits 340 and check again 330 repeatedly until one is found. The request can come in the form of a broadcast Wi-Fi access point with a specific name, or an advertised Wi-Fi Direct service. Once detected, the installed device will transmit 350 a response. Preferably, this response involves a secure Wi-Fi connection that is made between the installed device and the mobile device, and contains map co-ordinates for the location of the vehicle. If the installed device does not know any information concerning the location of the vehicle, the response is sent anyway, because it can still be used by the mobile device to determine the direction and proximity of the installed device and thus the vehicle. In an alternative implementation, the response can be broadcast in the beacon frame of a Wi-Fi access point, such as by encoding information in the access point SS id, thus eliminating the time required for one node to join the access point of the other. In a second alternative implementation, steps 330 and 340 are skipped, and the installed device repeatedly broadcasts the response after the Wi-Fi transceiver turns on 320, without ever waiting for a request from the mobile device.

FIG. 4 contains a flowchart that diagrams the steps performed in a mobile device that is being used as an aid to locate an installed device and its associated vehicle. Upon arriving within the vicinity of the chosen predicted location of the vehicle, the Wi-Fi in the mobile device is turned on 400 and the mobile device begins transmitting a request 410 for help in locating the vehicle. As previously described, the installed device in the vehicle transmits a response either as a result of hearing the request, or periodically as a function of the vehicle being at the correct place and time. If the mobile device does not detect this response 420, then the mobile device waits 430 and transmits 410 the request again. However, if it does detect a response, then the mobile device will extract 440 location information from the response. Possible formats of this response were described previously. The extracted location information may contain a map coordinate, or it may just contain an estimated distance or direction. Finally, the mobile device displays 450 whatever location information it has extracted to the person operating the mobile device and the person moves accordingly to retrieve the vehicle.

FIG. 5 illustrates an overview of ways of canceling or reversing commands that were previously executed by the installed device.

A command contains instructions to perform a specific action, and may contain criteria for when the action should be performed, such as at some location or time in the future. A command may also include one or more reversal codes for reversing or canceling the action if the installed device is unable to communicate with the central server and the command needs to be canceled or reversed. Henceforth the terms canceled and reversed are used interchangeably, it does not matter if the installed device receives the reversal code before or after execution of the command. These reversal codes are preferably randomly generated and unique for each command, such that a valid code for one command would not work to reverse a later second command, even if the second command called for the same action on the same vehicle. A reversal code might only reverse the command for a temporary period such as 24 hours, or it might permanently reverse the command. The installed device preferably supports multiple approaches of reversing a command, since certain approaches are more appropriate depending on the circumstances.

If the installed device 500 is currently in communication with a central server 510 through a Wi-Fi Internet access point 505, is expected to be in communication shortly, or if the command was designed to execute in the future and there is sufficient lead time such that the installed device is likely to be in communication with a central server before execution, then the command can be canceled by a new command from the central server. This is a preferred approach because it requires no driver interaction.

Otherwise, if a driver 550 has a mobile device 540 such as a smart-phone, then the driver can install a relaying application on the mobile device. The mobile device then becomes a relaying device and the installed device 500 can now communication with a central server 510 through the mobile device 540. The mobile device communicates with the central server either using a Wi-Fi Internet access point 505 or a cellular base station 515, depending on the settings and capabilities of the relaying device. In this way the original command can be canceled by a new command from the central server. In this approach, the driver does not need to manually enter a reversal code, but may need to install an application or move the relaying device within range of the installed device.

If the above approaches are not workable, then the lender may choose to give the vehicle driver a reversal code.

If a driver 550 has a mobile device 540, then the driver can instead directly enter a reversal code into the mobile device which can use Wi-Fi communications to send that code directly to the installed device 500, so long as the mobile device and installed device are within Wi-Fi range. This approach allows easy entry of codes by the driver when Internet access is not available.

Finally, if none of the above options are workable, then the driver 550 can directly enter the reversal code without the aid of any external device, for example, by toggling the vehicle's key 530 or pressing the vehicle start button in a pattern specified by the code. It should be apparent to one skilled in the art that there are other possible means for a driver to enter the reversal code, such as pressing the brake pedal or locking/unlocking the doors in the required pattern. The device senses that the code is being entered by monitoring an input tied to the vehicle ignition/key position 231 or the appropriate alternate input. Alternatively or additionally, the device might monitor the status of the OBD-II bus 230, since in most vehicles the ignition/key switch position can be sensed by monitoring this bus. This entry means, without the aid of an external device, is less familiar to the driver, is more cumbersome to enter, and may result in more complex installation, less code variety and less accurate code entry, however it is more universally available.

Additional modifications and improvements of the present invention may also be apparent to those of ordinary skill in the art. The particular combination of parts described and illustrated here is intended to represent only one embodiment of the present invention, and is not intended to serve as limitations of alternatives within the spirit and scope of the invention and the claims.

What is claimed is:

1. A system for using Wi-Fi to remotely retrieve a vehicle that is collateral for a loan, the system comprising:
a) a vehicle that is serving as collateral for a loan;
b) a location receiver attached to the vehicle, wherein the location receiver collects data from radio frequency signals for the purpose of determining the location of the vehicle;
c) a data storage which holds the collected location data;
d) an Wi-Fi transceiver attached to the vehicle, wherein the Wi-Fi transceiver uses a Wi-Fi link to transmit location data from the data storage toward a publicly routable Internet address;
e) a location predictor which analyzes the location data and predicts a location for the vehicle, wherein the predicted location is associated with a predicted time, and wherein the predicted time is not prior to the time at which the prediction is made;
f) a loan monitor which monitors the status of the loan associated with the vehicle; and
g) a user interface which presents the predicted location to an authorized user, wherein the presented predicted location is for a vehicle whose associated loan status has entered default.

2. The system of claim 1 further comprising a vehicle disable output, wherein the vehicle disable output can, when activated, disable the vehicle.

3. The system of claim 1 further comprising a warning output, wherein the warning output can, when activated, generate a warning detectable by the operator of the vehicle.

4. The system of claim 1 further comprising a mobile device, wherein the mobile device contains a user interface, and wherein the mobile device receives location information over Wi-Fi from the Wi-Fi transceiver and presents the received location information on the mobile device's user interface.

5. The system of claim 1 further comprising a cellular relaying device, wherein the cellular relaying device contains a cellular transceiver, and wherein the cellular relaying device communicates over Wi-Fi with the Wi-Fi transceiver and uses the cellular transceiver to forward information received from the Wi-Fi transceiver to a cellular base station.

6. A method for using Wi-Fi to remotely retrieve a vehicle that is collateral for a loan, the method comprising the steps of:
a) installing a Wi-Fi transceiver on a vehicle;
b) storing location data for the vehicle, wherein the location data allows for a determination of the vehicle's location;
c) establishing a first Wi-Fi link between the installed Wi-Fi transceiver and a first Wi-Fi node that is within Wi-Fi range of the installed Wi-Fi transceiver;
d) sending the stored location data over the first Wi-Fi link toward a publicly routable Internet address;
e) predicting a location for the vehicle from information contained in the location data, wherein the predicted location is associated with a predicted time, and wherein the predicted time is not prior to the time at which the prediction is made;
f) monitoring the status of a loan that is secured by the vehicle; and
g) retrieving the vehicle at the predicted location after the loan enters default.

7. The method of claim 6 further comprising the additional step of calculating a probability of the vehicle being present at the predicted location during the predicted time.

8. The method of claim 6 further comprising the additional steps of:
a) establishing a second Wi-Fi link between the first Wi-Fi node and a separate Wi-Fi node that is within range of the first Wi-Fi node; and
b) sending the location data over the second Wi-Fi link toward a publicly routable Internet address.

9. The method of claim 6 wherein the first Wi-Fi node from step c is attached to a cellular transceiver and further comprising the additional steps of:
a) establishing a cellular link between the cellular transceiver and a cellular base station; and 1 b) sending the location data over the cellular link.

10. The method of claim 6 further comprising the additional steps of:
a) sending a command to the installed Wi-Fi transceiver, wherein the command causes the installed Wi-Fi transceiver to transmit a Wi-Fi based signal when the vehicle is at the predicted location;
b) receiving the Wi-Fi based signal at a mobile device that is within Wi-Fi range of the installed Wi-Fi transceiver; and
c) locating the source of the Wi-Fi based signal by moving the mobile device in a direction that increases the received signal strength.

11. The method of claim 6 further comprising the additional steps of:
a) sending a command to the installed Wi-Fi transceiver, wherein the command causes the installed Wi-Fi transceiver to transmit a Wi-Fi based signal when the vehicle is at the predicted location;
b) receiving the Wi-Fi based signal at a mobile device that is within Wi-Fi range of the installed Wi-Fi transceiver;
c) locating the vehicle by decoding information present in the received Wi-Fi based signal; and
d) displaying the decoded information on the mobile device.

12. The method of claim 6 further comprising the additional steps of:
a) sending a command to the installed Wi-Fi transceiver, wherein the command causes the installed Wi-Fi transceiver to listen for a Wi-Fi based request signal when the vehicle is at the predicted location;
b) transmitting the Wi-Fi based request signal from a mobile device that is within Wi-Fi range of the predicted location;
c) transmitting a Wi-Fi based response signal from the installed Wi-Fi transceiver when the Wi-Fi based request signal is detected; and
d) locating the source of the Wi-Fi based response signal by moving the mobile device in a direction that increases the received signal strength.

13. The method of claim 6 further comprising the additional steps of:
a) sending a command to the installed Wi-Fi transceiver, wherein the command causes the installed Wi-Fi transceiver to listen for a Wi-Fi based request signal when the vehicle is at the predicted location;
b) transmitting the Wi-Fi based request signal from a mobile device that is within Wi-Fi range of the predicted location;
c) transmitting a Wi-Fi based response signal from the installed Wi-Fi transceiver when the Wi-Fi based request signal is detected;
d) locating the vehicle by decoding information present in the Wi-Fi based response signal; and
e) displaying the decoded location information on the mobile device.

14. The method of claim 6 further comprising the additional step of sending a command to the installed Wi-Fi transceiver, wherein the command causes the disabling of the vehicle at the predicted location.

15. A method for using Wi-Fi to remotely disable a vehicle at a specific location, the method comprising the steps of:
a) installing an electronic device on a vehicle, wherein the electronic device is capable of gathering information about the location of the vehicle and transmitting data over a Wi-Fi link;
b) storing location data for the vehicle, wherein the location data allows for a determination of the vehicle's location;
c) establishing a first Wi-Fi link between the installed device and a first Wi-Fi node that is within range of the installed device;
d) sending the stored location data over the first Wi-Fi link toward a publicly routable Internet address;
e) predicting a location for the vehicle from information contained in the location data, wherein the predicted location is associated with a predicted time, and wherein the predicted time is not prior to the time at which the prediction is made; and
f) sending a command to the installed device, wherein the command instructs the installed device to disable the vehicle at the predicted location.

16. The method of claim 15 further comprising the additional step of calculating a probability of the vehicle being present at the predicted location.

17. The method of claim 15 further comprising the additional step of retrieving the vehicle at the predicted location.

18. The method of claim 15 further comprising the additional steps of:
a) establishing a second Wi-Fi link between the installed device and a mobile device that is within Wi-Fi range of the installed device;
b) entering a reversal code on the mobile device, wherein the reversal code instructs the installed device to cancel the effect of a previously sent command; and
c) sending the reversal code to the installed device over the second Wi-Fi link.
